(19) United States
(12) Patent Application Publication
(10) Pub. No.: US 2026/0006692 A1
(43) Pub. Date: Jan. 1, 2026

(54) COLOR CHANGING LIGHTING ASSEMBLY

(71) Applicant: HKC-US, LLC, Memphis, TN (US)

(72) Inventors: Yupeng Chen, Dongguan City (CN); Fengyong Jiang, Dongguan City (CN)

(73) Assignee: HKC-US, LLC, Memphis, TN (US)

(21) Appl. No.: 19/321,970

(22) Filed: Sep. 8, 2025

Related U.S. Application Data
(63) Continuation of application No. 17/893,809, filed on Aug. 23, 2022, now Pat. No. 12,426,136.

(30) Foreign Application Priority Data
Jul. 19, 2022 (CN) 202210872310.7

(51) Int. Cl. H05B 45/20; H05B 45/46; H05B 45/50

(52) U.S. Cl. CPC H05B 45/20; H05B 45/46; H05B 45/50

(57) ABSTRACT

A circuit for a lighting assembly includes a power supply, a first light source connected with an output of the power supply, and a second light source connected with the output of the power. The first and second light sources are connected with the output of the power supply in parallel. At least one integrated chip including a driver is configured to regulate the current to each of the first light source and the second light source. A switch is configured to select a brightness level of each of the first and second light sources configured to appear similar to the characteristics of a halogen or incandescent light source.

### CROSS-REFERENCE TO RELATED APPLICATIONS

This application is a continuation of and claims priority to U.S. application Ser. No. 17/893,809, entitled “Color Changing Lighting Assembly” and filed on Aug. 23, 2022, the contents of which are incorporated herein by reference in its entirety. U.S. application Ser. No. 17/893,809 claims priority to Chinese Application No. 202210872310.7 to Yupeng Chen et al. filed on Jul. 19, 2022, the contents of which are incorporated herein by reference in its entirety.

### FIELD

The present subject matter generally relates to a color changing lighting assembly, specifically a color changing lighting assembly configured to produce various wavelengths of light via two or more light sources.

### BACKGROUND

It is often desired to selectively dim lights, particularly in residential and commercial settings. When a halogen or incandescent bulb is dimmed, the color temperature of the light changes to be warmer shade (e.g. 3100 K to 1850 K). However, when an LED is dimmed by an external dimmer, the dimming does not affect the color temperature of the LED. Therefore, dimming an LED does not produce the same warming effect that dimming a halogen or incandescent bulb produces.

### BRIEF DESCRIPTION

Aspects and advantages of the invention will be set forth in part in the following description, or may be obvious from the description, or may be learned through practice of the invention.

According to some aspects of the present disclosure, a circuit for a lighting assembly includes a power supply, a first light source connected with an output of the power supply, and a second light source connected with the output of the power. The first and second light sources are connected with the output of the same power supply in parallel. At least one integrated chip including an internal driver is configured to regulate the variable current to each of the first light source and the second light source. A switch is configured to select a brightness level of each of the first and second light sources.

These and other features, aspects, and advantages of the present disclosure will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 is a schematic diagram of a lighting assembly including one or more light sources, according to various examples;

FIG. 2 is a graphical representation of Correlated Color Temperature as it relates to brightness for the lighting assembly and/or the light sources of FIG. 1 (i.e., the warm on dim lighting assembly) compared to a halogen or incandescent light source, according to various examples;

FIG. 3A is a schematic diagram of a circuit of the lighting assembly of FIG. 1, according to various examples;

FIG. 3B is a schematic diagram of a circuit of the lighting assembly of FIG. 1, according to various examples;

FIG. 3C is a schematic diagram of a circuit of the lighting assembly of FIG. 1, according to various examples;

FIG. 4 is a flow diagram of a first method of operating a lighting assembly, according to various examples;

FIG. 5 is a flow diagram of a second method of operating a lighting assembly, according to various examples; and

FIG. 6 is a flow diagram of a third method of operating a lighting assembly, according to various examples.

Repeat use of reference characters in the present specification and drawings is intended to represent the same or analogous features or elements of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

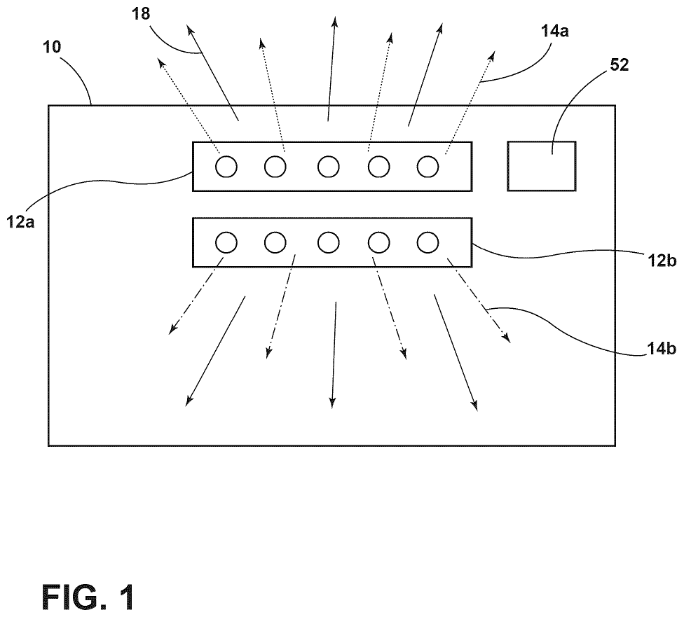

Referring now to FIG. 1, the present disclosure is generally directed to a lighting assembly 10 including a first light source 12a and a second light source 12b. The first light source 12a is configured to produce a first light 14a, and the second light source 12b is configured to produce a second light 14b. The first and second light sources 12a, 12b may be illuminated independently or simultaneously, as discussed in more detail elsewhere herein. In various examples, each of the first and second light sources 12a, 12b is configured as a light-emitting diode (LED). In other examples, one or both of the first and second light sources 12a, 12b may be a plurality of LEDs (e.g., an LED string) configured to illuminate as a single unit. In still other examples, any other operable light source 12a, 12b may be used without departing from the scope of the present disclosure.

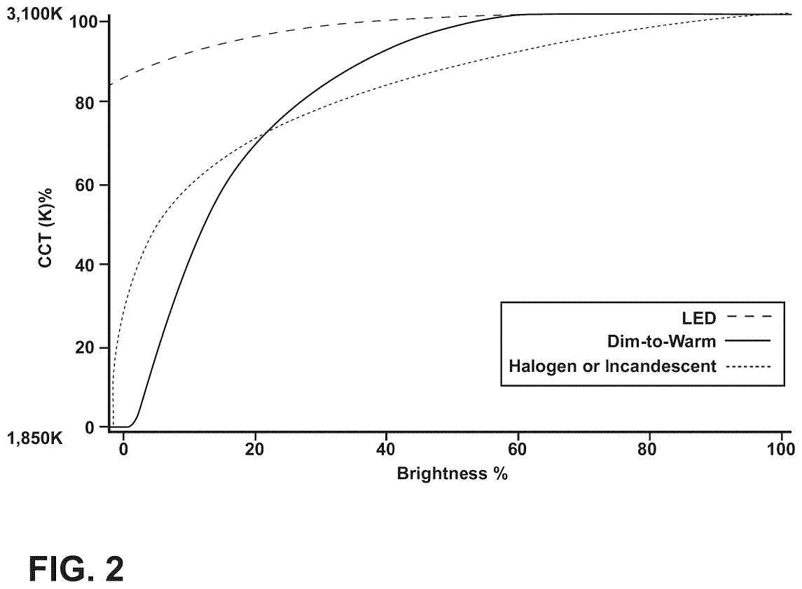

FIG. 2 illustrates a graphical representation of Correlated Color Temperatures if a halogen or incandescent light source compared with the disclosed LED light sources 12a, 12b of the lighting assembly 10 (labeled “Warm on Dim”). Referring now to FIGS. 1 and 2, the first light source 12a is configured as a “cold LED” such that the first light 14a has a Correlated Color Temperature (CCT) within a range of about 3000 Kelvin degrees (K) and about 4000K. It will be understood that the first light 14a may have a CCT of any value or subset of values within this range of values without departing from the scope of the present disclosure. For example, the first light 14a may have a CCT of about 3100K. The second light source 12b is configured as a “warm LED” such that the second light 14b has a CCT within a range of about 1500K to about 3000K. It will be understood that the second light 14b may have a CCT of any value or subset of values within this range of values without departing from the scope of the present disclosure. For example, the second light 14b may have a CCT of about 1850K. The first and second light sources 12a, 12b are configured to be adjustable to produce a combined light 18 that can be adjusted to have one or more CCTs within a range of about 1500K to about 3500K. For example, the first and second light sources 12a, 12b may configured to produce the combined light 18 to be adjusted so that the CCT ranges between about 1850K and about 3100K, similar to a halogen or incandescent light source.

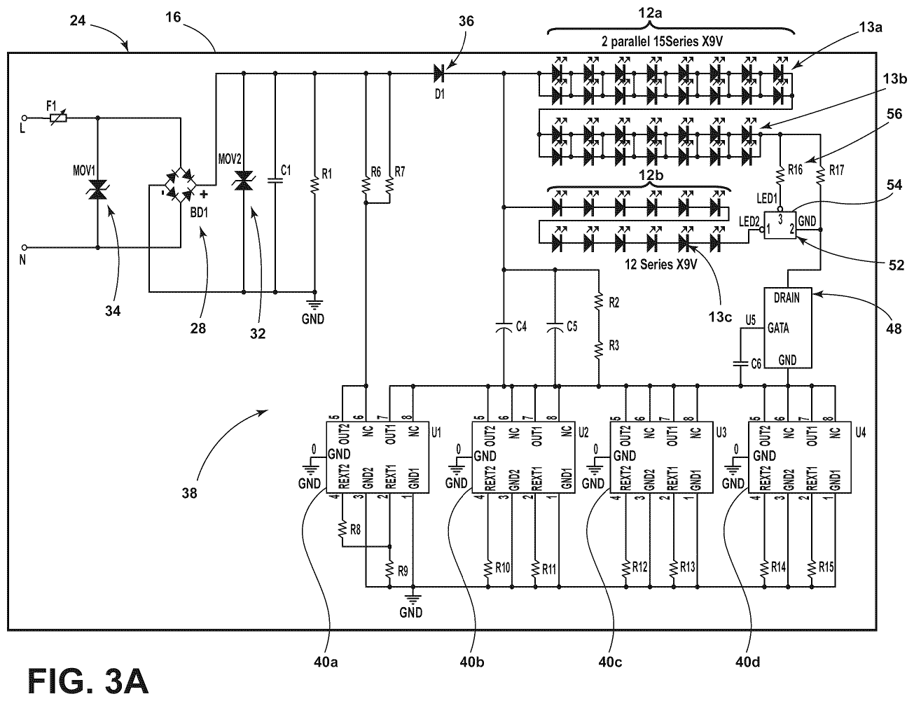

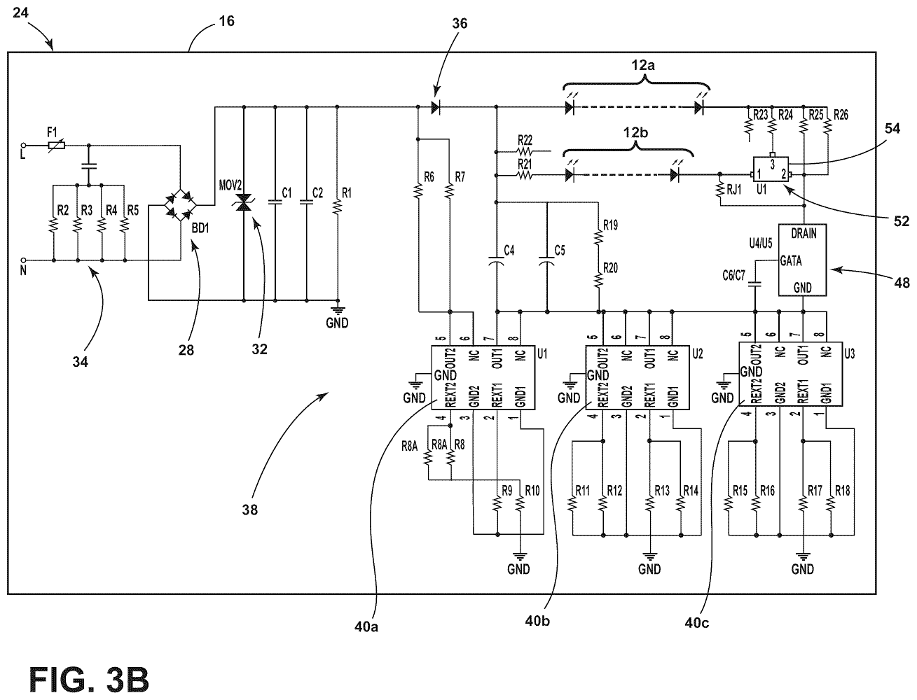

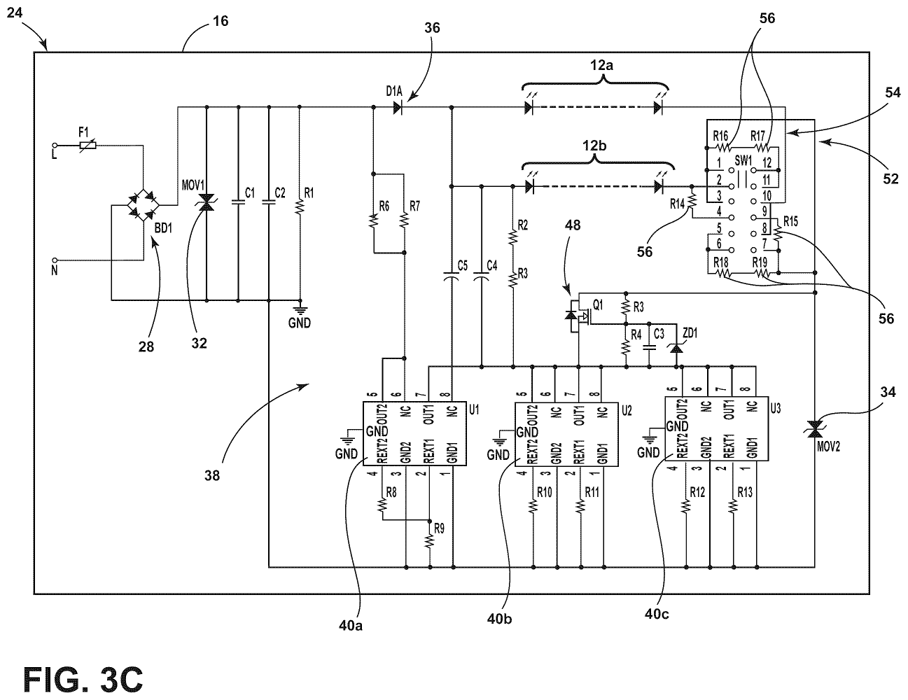

FIGS. 3A-3C illustrate various configurations for a lighting circuit 24. In each of the configurations, the lighting assembly 10 includes a printed circuit board (PCB) 16 configured to support the lighting circuit 24 for operating the first and second light sources 12a, 12b.

As shown in FIGS. 3A-3C, the lighting circuit 24 may include a diode bridge 28 configured to convert AC power to DC power. The diode bridge 28 is configured to act as a DC power supply. In various examples, a first surge protector 32 may be electrically coupled with the output of the diode bridge 28. A second surge protector 34 may be electrically coupled with the input of the diode bridge 28. As shown in FIG. 3C, the second surge protector 34 may be formed of one or more resistors and one or more capacitors. In other examples, only the first surge protector 32 may be used. In still other examples, one or more surge protectors 32 may be located in other locations within the light circuit 24.

The first light source 12a is electrically coupled with the output of the diode bridge 28. A diode 36 may be positioned between the diode bridge 28 and the first light source 12a. As shown in FIG. 3A, the first light source 12a may include a first series of LEDs 13a connected in parallel with a second series of LEDs 13b. In various examples, the first and second series of LEDs 13a, 13b may be configured to selectively receive current as a single light source (i.e., the first light source 12a). For example, the first and second series of LEDs 13a, 13b may be two parallel 15 units of series LEDs. However, it is contemplated that other LED combinations may be used.

The second light source 12b is electrically coupled with the output of the diode bridge 28 such that the first and second light sources 12a, 12b are in parallel. As shown in FIG. 3A, the first light source 12b may include a third series of LEDs 13c configured to receive current as a single light source (i.e., the second light source 12b). As illustrated, the third series of LEDs 13c may be 12 units of series LEDs. In other examples, the third series of LEDs 13c may be two parallel 15 units of series LEDs.

Referring again to FIGS. 3A-3C, a plurality of integrated circuits 38 may be coupled with the PCB 16. Each of the plurality of integrated circuits 38 may be electrically coupled with the output of the diode bridge 28 and the first and second light sources 12a, 12b. For example, as illustrated in FIG. 3A, the plurality of integrated circuits 38 may include four constant-current control integrated circuits 40a, 40b, 40c, 40d. Each of the four constant-current control integrated circuits 40a, 40b, 40c, 40d may be electrically coupled in parallel and may be configured to regulate current to each of the first and second light source 12a, 12b. In other examples, as shown in FIGS. 3B and 3C, three constant-current control integrated circuits 40a, 40b, 40c may be used. It is contemplated that any number of constant-current control integrated circuits may be used without departing from the scope of the present disclosure.

In various examples, each of the integrated circuits 40a, 40b, 40c, 40d may include an integrated FET driver. These constant-current control integrated circuits 40a, 40b, 40c may be configured to provide the requisite power for the first and second light sources 12a, 12b. For example, each integrated circuit 40a, 40b, 40c may be a JW19819 manufactured by Joulwatt, a WS 9621 manufactured by Winsemi, or any other comparable integrated circuit with an integrated FET driver.

In various examples, the integrated circuits 40a, 40b, 40c may be configured to operate in tandem to control current to one or both of the first and second light sources 12a, 12b. In other examples, each light sources 12a, 12b is operated by a separate integrated circuit 40a and respective driver. In other words, one of the integrated circuits 40a, 40b, 40c may be configured to control current to the first light source 12a, and another of the integrated circuits 40a, 40b, 40c may be configured to control current to the second light source 12b. It is contemplated that any combination of the integrated circuits 40a, 40b, 40c may be used to control one or both of the first and second light sources 12a, 12b without departing from the scope of the present disclosure.

Referring again to FIGS. 3A-3C, the lighting circuit 24 may further include a transistor 48 operably coupled with the PCB 16. The transistor 48 may be operably coupled with one or more of the integrated circuits 40a, 40b, 40c. The transistor 48 is configured to reduce light fluctuations when the lighting circuit 24 is powered. In various examples, as shown in FIG. 3B, the transistor 48 may be a depletion MOSFET configured to act as a regulated switch.

Referring now to FIGS. 1-3C, a switch 52 is coupled with the PCB 16 and electrically coupled with each of the first and second light sources 12a, 12b. The switch 52 is configured to select the brightness of the combined light 18 produced by the lighting assembly 10 shown in FIGS. 3A-3C and, subsequently, adjusts the CCT of the combined light 18. As shown in FIG. 2, when the brightness of the combined light 18 is increased, the CCT of the combined light 18 also increases. To control the brightness and the CCT of the combined light 18, the switch 52 is configured to individually select the level of brightness of each of the first and second light sources 12a, 12b as a dimming cycle is initiated. The switch 52 may be configured as any type of external switching device including but not limited to a remote control, a rheostat, a slide switch, a digital dimmer, etc. It will also be understood that any number of switches may be used together or separately to generate various lighting configurations without departing from the scope of the present disclosure.

As shown in FIG. 3A-3C, the switch 52 may include a separate integrated circuit 54. The range of CCT as related to the brightness level of the combined light 18 (FIG. 1) is set by the configuration of the integrated circuit during manufacturing and may be adjusted to end user specifications. In various examples, a plurality of resistors 56 may be coupled with the switch 52 and may be configured to provide variable resistance to provide varying levels of brightness in each of the first and second light sources 12a, 12b. It will be understood that any integrated circuit may be used that is configurable to operate as a programmable switch as described without departing from the scope of the present disclosure.

Referring again to FIGS. 1-3C, in operation, an electrical input is provided from a power source to the diode bridge 28. The power is converted from AC power to DC power as it passes through the diode bridge 28. One or more surge protectors (e.g., the first and/or second surge protectors 32, 34) are positioned to prevent a power surge before the diode bridge 28 and/or after the diode bridge 28. A user operates the switch 52 to select a specific brightness for the lighting assembly 10. The switch 52 communicates with the plurality of integrated circuits 38 what level of brightness should be provided for each of the first light source 12a and the second light source 12b. Power is then supplied to each of the first and second light sources 12a, 12b to maintain the desired CCT for the selected brightness level. The regulation of the power to each of the first and second light sources 12a, 12b is controlled by the plurality of integrated circuits 38.

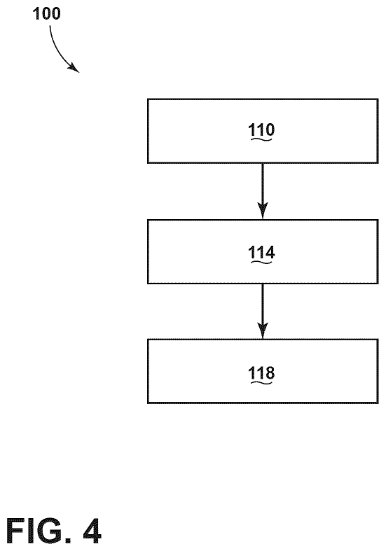

The switch 52 may operate using one or more methods 100, 120, 130, as described below. As shown in FIGS. 1-4, a first method 100 of operating a lighting assembly 10 to produce a warm on dim lighting effect includes a step 110 of reducing a first current to a first light source 12a at a rate of reduction. The first light source 12a is a cool LED, as described elsewhere herein. The method 100 further includes a step 114 of increasing a second current to a second light source 12b at a rate of increase, wherein the rate of reduction of current to the first light source 12a is greater than the rate of increase of current to the second light sources 12b. The second light source 12b is a warm LED, as described elsewhere herein. The method 100 includes another step 118 of reducing the first current and increasing the second current until a predetermined dimming cycle is complete.

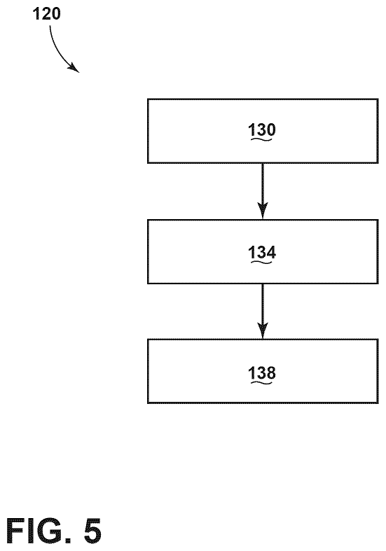

As shown in FIGS. 1-3 and 5, a second method 120 of operating a lighting assembly 10 to produce a warm on dim lighting effect includes a step 130 reducing a first current to a first light source 12a at a first rate of reduction. The first light source 12a is a cool LED, as described elsewhere herein. The method 120 further includes a step 134 of reducing a second current to a second light source 12b at a second rate of reduction, wherein the first rate of reduction is greater than the second rate of reduction. The second light source 12b is a warm LED, as described elsewhere herein. The method 120 includes another step 138 of reducing the first and second currents until a predetermined dimming cycle is complete.

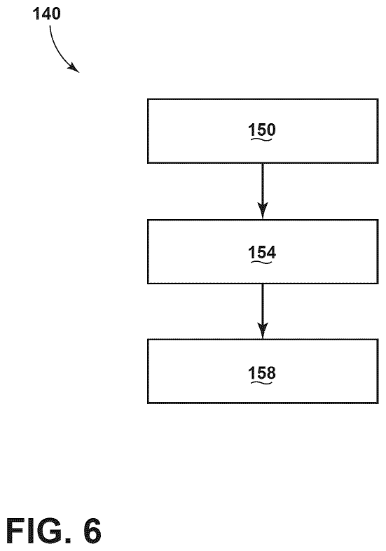

As shown in FIGS. 1-3 and 6, a third method 140 of operating a lighting assembly 10 to produce a warm on dim lighting effect includes a step 150 reducing a first current to a first light source 12a at a rate of reduction and a step of reducing a second light source 12b at the rate of reduction. The first light source 12a is a cool LED, and the second light source 12b is a warm LED, as described elsewhere herein. The method 140 further includes a step 154 of halting the reduction of the second current when the first and second currents result in a dimming level of about 60%. Another step 158 includes continuing to reduce the first current at the first rate of reduction until a predetermined dimming cycle is complete. It will be understood that the methods 100, 120, 140 are examples of by step reduction and that any number of steps can be used in connection with any one of the methods to create stepless dimming of the lighting assembly 10 through adjustment of the first and second light sources 12a, 12b until a desired brightness level for the combined light 18 is reached.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A circuit for a lighting assembly comprising:
a power supply;
a first light source connected with an output of the power supply;
a second light source connected with the output of the power, wherein the first and second light sources are connected with the output of the power supply in parallel;
at least one integrated circuit including a driver, wherein the at least one integrated circuit is configured to regulate current to each of the first light source and the second light source; and
a switch configured to select a brightness level of each of the first and second light sources.

2. The circuit of claim 1, wherein the first light source is a first series of light emitting diodes and the second light source is a second series of light emitting diodes.

3. The circuit of claim 1, wherein the first light source is a two series of light emitting diodes in parallel and the second light source is a single series of light emitting diodes.

4. The circuit of claim 1, wherein the first light source is configured to produce a first light having a Correlated Color Temperature from about 3000 Kelvin degrees to about 4000 Kelvin degrees, and the second light source is configured to produce a second light having a Correlated Color Temperature from about 1500 Kelvin degrees to about 3000 Kelvin degrees.

5. The circuit of claim 1, wherein the at least one integrated circuit is a plurality of circuits each having an integrated internal driver.

6. The circuit of claim 5, wherein one of the plurality of circuits is configured to regulate current to the first light source and another of the plurality of circuits is configured to regulate current to the second light source.

7. The circuit of claim 1, wherein the switch includes a switch integrated circuit electrically coupled with one or more resistors.

8. The circuit of claim 1, wherein the switch is configured to determine a corresponding Correlated Color Temperature for the selected brightness level and the at least one integrated circuit is configured to provide current to each of the first and second light sources to achieve the selected brightness level and the corresponding Correlated Color Temperature.

9. The circuit of claim 1, further comprising:
a transistor configured to reduce fluctuations in illumination of the first and second light sources.

10. The circuit of claim 1, further comprising:
a diode bridge configured to convert power from the power supply to DC power; and
one or more surge protectors electrically coupled with the diode bridge.

11. A circuit for a lighting assembly comprising:
a power supply;
a diode bridge configure to convert power from the power supply to DC power;
a first light source connected with an output of the power supply and configured to produce a first light having a Correlated Color Temperature from about 3000 Kelvin degrees to about 4000 Kelvin degrees;
a second light source connected with the output of the power and configured to produce a second light having a Correlated Color Temperature from about 1500 Kelvin degrees to about 3000 Kelvin degrees, wherein the first and second light sources are connected with the output of the power supply in parallel;
a plurality of integrated circuits configured to regulate the current to each of the first light source and the second light source, wherein each of the plurality of integrated circuits includes a driver; and
a switch configured to select a brightness level of each of the first and second light sources.

12. The circuit of claim 11, wherein the switch includes an integrated circuit configured to determine a corresponding Correlated Color Temperature for the selected brightness level and the plurality of integrated circuits is configured to provide current to each of the first and second light sources to achieve the selected brightness level and the corresponding Correlated Color Temperature.

13. The circuit of claim 11, wherein the first light source is a first series of light emitting diodes and the second light source is a second series of light emitting diodes.

14. The circuit of claim 11, wherein the first light source is a two series of light emitting diodes in parallel and the second light source is a single series of light emitting diodes.

15. A method of controlling a lighting assembly, comprising:
providing electrical input from a power supply to a diode bridge;
programming a switch integrated circuit to receive input and determine a corresponding Correlated Color Temperature for a lighting assembly, wherein the input is a selected brightness level;
programming one or more control integrated circuits to receive input from the switch integrated circuit; and
regulating current to first and second light sources via the one or more control integrated circuits to illuminate the first and second light sources simultaneously in response to the input from the switch circuit to achieve the selected brightness level and the corresponding Correlated Color Temperature.
